(19) United States
(12) Patent Application Publication
(10) Pub. No.: US 2026/0087181 A1
(43) Pub. Date: Mar. 26, 2026

(54) CONTROLLING ACCESS TO DIGITAL KEY

(71) Applicant: Google LLC, Mountain View, CA (US)

(72) Inventors: Wenhui Kao, San Jose, CA (US); Alok Chandel, Sunnyvale, CA (US); Eerik J. Helmick, Mountain View, CA (US); Adam M. Bar-Niv, Los Altos, CA (US)

(21) Appl. No.: 19/105,025

(22) PCT Filed: Jun. 28, 2023
(86) PCT No.: PCT/US2023/026490

§ 371 Date: Feb. 19, 2025

(51) Int. Cl. G06F 21/81; G06F 1/3212; G06F 21/31

(52) U.S. Cl. CPC G06F 21/81; G06F 1/3212; G06F 21/31

(57) ABSTRACT

A battery-powered portable computing device, including a digital key for providing access to an external secure system, 2024/043979 detects that a remaining battery energy has reduced to a second predefined level higher than a first predefined level, wherein at least a portion of the device is programmed to shut down when the remaining battery energy drops to the first predefined level. In response to the detection, the device prompts a user to selec t a configuration to allow′ use of the digital key when at least a portion of the device has shut down and allows use of the digital key-after the device is shut down if allowed by the user selected configuration.

### CROSS-REFERENCE TO RELATED APPLICATION

This application claims the benefit of U.S. Provisional Ser. No. 63/373,301, filed Aug. 23, 2022, which is incorporated by reference herein in its entirety.

### BACKGROUND

Portable computing devices (for example, wearable computing device such as smart phones and smart watches) are sometimes conveniently configured with digital key technology, enabling the portable computing devices to access (e.g., unlock and/or make use of) one or more secure systems such as vehicles, buildings, and secure storage devices such as safes, among other possibilities. For example, such a portable computing device is sometimes equipped with a near field communication (NFC) module configured to interact with a corresponding NFC module of the secure system when placed in close enough proximity to the secure system, and the portable computing device is sometimes configured with a digital key and arranged to engage in digital key exchange and authentication operations with the secure system via NFC communication. Alternatively, the portable computing device sometimes uses ultra-wide band (UWB) or another form of communication. The digital key in the portable computing device thereby conveniently takes the place of a physical key for accessing the secure system.

### SUMMARY

A portable computing device configured with a digital key may be further configured to give its user control over whether the portable computing device will allow access to the digital key when a substantial portion of the portable computing device has shut down due to low battery energy. In particular, the portable computing device may be configured to detect when its battery energy has dropped to a threshold low level that is higher than a level at which the portable computing device would shut down, and the portable computing device may be configured to respond by prompting its user to approve the portable computing device transitioning to an operational state in which the portable computing device will allow access to the digital key when the substantial portion of the portable computing device has shut down due to low battery energy. Further, the portable computing device may be configured to require user authentication as a condition to allowing the portable computing device to transition to this operational state.

Accordingly, in one respect, disclosed is a method including detecting, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, outputting, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transitioning, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

In another respect, disclosed is an apparatus includes a short-range wireless communication interface; a secure element programmed with a digital key operable through the short-range wireless communication interface to provide access to an external secure system, a battery; a user interface to engage in authentication of a user, wherein, when remaining energy of the battery has reduced to a first predefined level, the user interface is programmed to shut down and the authentication of the user is prevented; and a controller to detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

In yet another respect, disclosed is a non-transitory machine-readable medium comprising instructions which, when executed by at least one processor, cause the at least one processor to detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

In still another respect, disclosed is a system that includes various means for carrying out each of the operations described herein.

These as well as other aspects, advantages, and alternatives will become apparent to those of ordinary skill in the art by reading the following detailed description, with reference, where appropriate, to the accompanying drawings. Further, the descriptions provided in this summary and below are intended to illustrate the invention by way of example only and not by way of limitation.

### BRIEF DESCRIPTION OF THE DRAWINGS

FIG. 1 illustrates an example use of a digital key to access an external secure system.

FIG. 2 is a simplified block diagram of an example portable computing device.

FIG. 3 illustrates an example configuration interface of the example portable computing device.

FIG. 4 illustrates another example configuration interface of the example portable computing device.

FIG. 5 illustrates an example user authentication prompt dialog of the example portable computing device.

FIG. 6 illustrates controlling access to a digital key according to an implementation.

### DETAILED DESCRIPTION

A portable computing device including a digital key may require a user to unlock access to the portable computing device for the user to then make use of the digital key to access a secure system (external to the portable computing device). For instance, the portable computing device may operate by default in a device-locked state in which the portable computing device blocks access to and use of the digital key, and the portable computing device may provide a user interface through which a user can provide user authentication credentials (e.g., a passcode or biometric data) to the portable computing device, in response to which the portable computing device transitions to a device-unlocked state in which the portable computing device allows access to and use of the digital key.

A technical problem with this arrangement, however, is that, when the portable computing device's battery energy reaches a low enough level, it may be impossible for the user to unlock the portable computing device, and it may therefore be impossible for the user to use the digital key to access the secure system. In particular, the portable computing device may require a sufficient level of remaining battery energy for the portable computing device's user interface to function. When the portable computing device's battery energy drops below that level, the portable computing device may effectively “shut down” from the user's perspective (although at least a portion of the portable computing device may still be operable for a time).

Following a shut down, the portable computing device may still have enough battery energy for a time to power access to and use the digital key (e.g., to engage in NFC communication and digital key exchange and authentication with the secure system). However, once the portable computing device shuts down due to low remaining battery energy, the portable computing device's user interface may not function, and so the user may be unable to unlock the portable computing device even though some functionality of the portable computing device is still operational and may therefore be unable to use the digital key. This situation could be especially inconvenient if the user does not have access to a power source to charge the battery of the portable computing device and if the user needs to use the digital key to gain access to the secure system.

One solution to this problem is for the portable computing device to have a user-selectable configuration setting that, when turned on, will cause the portable computing device to allow use of the digital key without user authentication once the portable computing device shuts down due to low battery energy. With this setting turned on, the portable computing device may generally require user authentication to unlock the portable computing device in order to allow use of the digital key, but when the portable computing device shuts down due to low battery energy, the portable computing device may transition to a state in which the portable computing device will allow use of the digital key for a time without requiring the user authentication and thus without needing to unlock the portable computing device.

Unfortunately, however, this solution is itself problematic, as the solution may allow a rogue actor to gain access to the digital key by waiting until the portable computing device shuts down due to low battery energy. In particular, if the user has turned on the configuration setting that allows use of the digital key without user authentication once the portable computing device shuts down due to low battery energy, a thief or other bad actor who gets ahold of the portable computing device could simply wait until the portable computing device shuts down due to low battery energy, and could then use the digital key for a time without user authentication, thereby gaining unauthorized access to the secure system.

As noted above, the technology described in present disclosure provides a mechanism to better control access to a digital key included in a battery-powered portable computing device when the portable computing device has shut down due to low battery energy. In accordance with the disclosure, the portable computing device detects when its battery energy has dropped to a threshold low level that is not low enough for the portable computing device to responsively shut down. For example, if a portion of the portable computing device (such as the user interface, for example) shuts down when its battery energy reaches approximately 2% of the battery's capacity, the portable computing device detects when its battery energy has dropped to a threshold low level in the range of approximately 5% to 15% of its capacity. Upon detecting that the portable computing device's battery energy has dropped to that threshold low level, the portable computing device prompts the user to turn on the configuration setting that allows use of the digital key when the portable computing device shuts down due to low battery energy, and the portable computing device requires user authentication to allow the user to responsively turn on that configuration setting. After the user turns on that configuration setting in response to the prompt and with user authentication, the portable computing device may then be configured to allow use of the digital key without user authentication once the portable computing device shuts down due to low battery energy. After the user turns on the configuration setting, the portable computing device may still require the portable computing device to be unlocked to use the digital key, but when the portable computing device shuts down due to low battery energy, the portable computing device allows use of the digital key without the portable computing device being unlocked by user authentication.

Example methods, devices, and systems are described herein. It should be understood, however, that any disclosed embodiment is not necessarily to be construed as preferred or advantageous over other embodiments unless stated as such. Further, variations from the specific arrangements and processes disclosed are possible. For instance, various disclosed entities, components, connections, operations, and other elements could be added, omitted, distributed, replicated, re-located, re-ordered, combined, or changed in other ways. In addition, various disclosed technical operations could be implemented at least in part by a processing unit programmed to carry out the operations or to cause one or more other entities to carry out the operations.

As discussed above, a battery-powered portable computing device may be configured with digital key technology to facilitate accessing a secure system. Without limitation, a representative portable computing device may be a wearable computing device, smart phone, a tablet computer, a laptop computer, a gaming device, a smart watch or other wearable device, a medical device, an embedded or implanted device, and/or any type of computing device that could accompany a user as the user moves from place to place. Further, without limitation, a representative secure system may be a vehicle (e.g., a car, truck, boat, plane, motorcycle, etc.), a building (e.g., an office, a house or other dwelling such as an apartment, condominium or townhome, etc.), a safe, a security system, and/or any physical system that can be locked and require a key to access. The act of accessing the secure system may, for example, involve gaining entry to the secure system, such as unlocking a vehicle or unlocking a door of a building, etc. Alternatively, or additionally, the act of accessing the secure system may involve changing a state of the secure system, such as turning on a car engine, disarming a security system, etc.

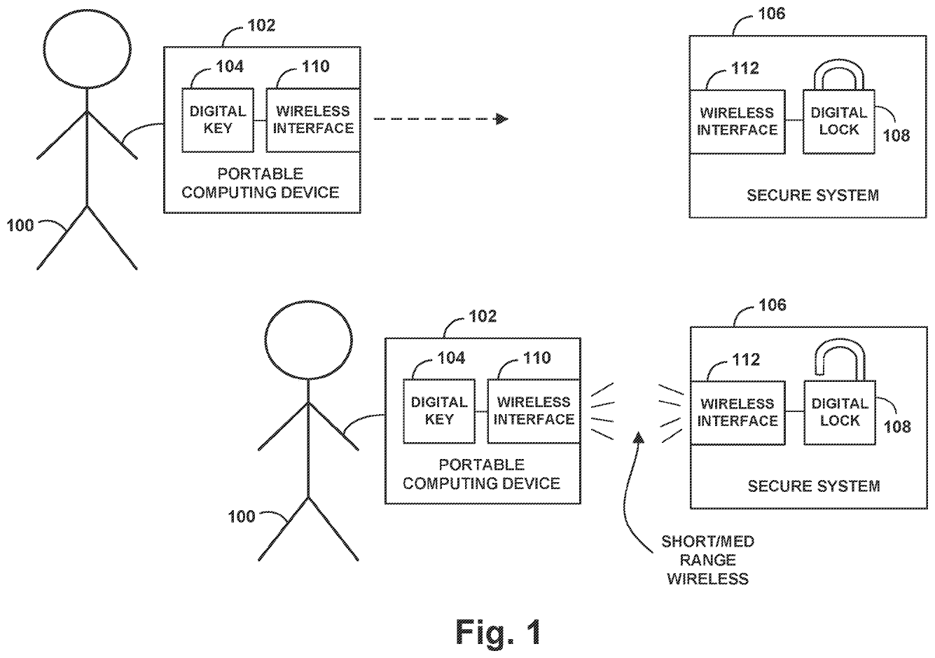

FIG. 1 illustrates an example use of a digital key to access an external secure system. FIG. 1 shows user 100 having portable computing device 102 that includes at least one digital key 104 and using the digital key to gain access to secure system 106 (external to portable computing device 102) that includes digital lock 108.

As illustrated, example portable computing device 102 and secure system 106 are equipped with respective wireless communication interfaces supporting direct wireless communication with each other. Namely, portable computing device 102 includes wireless communication interface 110, and secure system 106 includes corresponding wireless communication interface 112. These wireless communication interfaces may be NFC interfaces, supporting peer-to-peer communication between peers within very close range of each other (e.g., on the order of up to approximately four centimeters), to help avoid unintended communication. Alternatively, the interfaces could take other forms, such as ultra-wide band (UWB) or Bluetooth interfaces for instance.

As shown in FIG. 1, digital lock 108 of secure system 106 may be in a locked state by default, thereby preventing access to the secure system. When user 100 brings portable computing device 102 within close enough range (e.g., a distance between the portable computing device and the secure system sufficiently small to allow near field communications to be operable) of secure system 106, however, digital key 104 in the portable computing device may be used to wirelessly communicate with digital lock 108 in the secure system to unlock digital lock 108 and provide the user with access to the secure system. With NFC, for instance, when user 100 brings wireless communication interface 110 of portable computing device 102 close enough to wireless communication interface 112 of secure system 106, inductive coupling between the two interface modules may trigger signaling between the portable computing device and the secure system, to authenticate digital key 104 and to unlock digital lock 108.

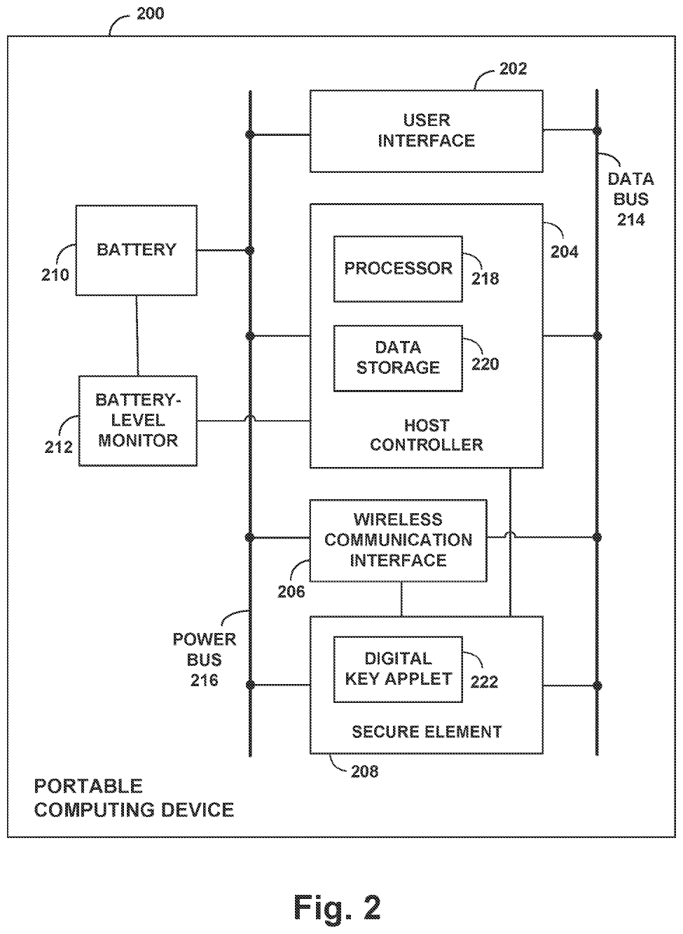

FIG. 2 is a simplified block diagram of an example portable computing device. Portable computing device 200 (which may be an example of portable computing device 102 of FIG. 1) includes user interface 202, host controller 204, wireless communication interface 206, secure element 208, battery 210, and battery-level monitor 212. These components may be interconnected, integrated, and/or communicatively linked together in various ways. For instance, FIG. 2 depicts user interface 202, host controller 204, wireless communication interface 206, and secure element 208 being interconnected by data bus 214; battery 210 being interconnected with user interface 202, host controller 204, wireless communication interface 206, and secure element 208 by power bus 216; and battery-level monitor 212 being interconnected with battery 210 and host controller 204. Further, FIG. 2 depicts direct hardware connections between secure element 208 and wireless communication interface 206 and between the secure element and host controller 204. Other arrangements are also possible. Without limitation, for example, portable computing device 200 may include other direct connections between its components.

User interface 202 may include input and output components to facilitate interaction with a user of portable computing device 200, such as for user authentication and user interaction with various applications on the portable computing device. For example, user interface 202 may include a presence-sensitive interface, such as a touch screen, which may display graphical user interfaces (GUIs) to the user and may receive input from the user. Further, user interface 202 may include other input components such as a microphone, a keypad, and a biometric sensor, and other output components such as a sound speaker and a haptic interface, among other possibilities.

Host controller 204 may operate to carry out or cause portable computing device 200 to carry out various device operations described here. As shown, host controller 204 may include at least one processor 218 (e.g., one or more general purpose processors such as microprocessors and/or one or more special purpose processors such as application specific integrated circuits), and at least one non-transitory data storage 220 (e.g., one or more volatile and/or non-volatile storage components, such as magnetic, optical, and/or flash storage). Non-transitory data storage 220 may store program instructions (not shown), which may be executed by processor 218 to cause portable computing device 200 to carry out various device operations. For instance, the program instructions may define an operating system (OS) as well as various applications configured to run on the OS. Further, non-transitory data storage 220 may store reference data (not shown), such as configuration settings, state data, etc., to facilitate operation of the portable computing device.

Wireless communication interface 206 may include a short or medium range wireless communication interface, such as an NFC, UWB, or Bluetooth communication interface, among other possibilities. For example, wireless communication interface 206 may include an active NFC interface to facilitate short-range wireless communication with a corresponding NFC interface of a secure system. A representative NFC interface may include an NFC controller and a loop antenna to facilitate inductive coupling with a corresponding NFC interface of the secure system. Wireless communication interface 206 may also implement other functions.

Secure element 208 may be a separate processing subsystem of portable computing device 200, protected from unauthorized access and configured to run a limited set of applications and to store confidential and cryptographic data. In the example portable computing device 200, secure element 208 may act as a secure or trusted execution environment for digital key applet 222, which hosts the portable computing device's digital key(s) (such as digital key 104) and implements transactions between the portable computing device and the secure system. In various implementations, secure element 208 may be configured as hardware circuitry (e.g., as a system on a chip (SoC)) with its own processor, memory, and persistent storage, and with a protected OS that may require access requests to be authenticated by cryptographic keys.

As shown above, secure element 208 may have direct connections with wireless communication interface 206 and with host controller 204. The direct connection between secure element 208 and wireless communication interface 206 may enable digital key applet 222 to engage in wireless communication with a secure system (such as secure system 106), without having host controller 204 have access to those communications. Likewise, the direct connection between secure element 208 and host controller 204 may enable the host controller to engage in privileged access and management of the secure element, such as to lock or unlock the secure element and to update properties of one or more digital keys, without giving other components access to those communications.

Battery 210 may be configured to provide energy to support operation of portable computing device 200 when the portable computing device is not connected with another energy source. For example, battery 210 may provide energy to power components such as user interface 202, host controller 204, wireless communication interface 206, and secure element 208. Battery 210 may be rechargeable and may take various forms, examples of which include nickel metal hydride (NiMH), nickel cadmium (NiCd), Lithium Ion (Li-Ion), and lithium polymer (Li-Poly).

Battery-level monitor 212 may operate to regularly monitor the remaining energy level of battery 210 and provide host controller 204 with a signal that indicates a latest determined remaining battery energy level, such as a percentage of remaining battery capacity or another suitable metric. Battery-level monitor 212 may take various forms, such as a voltmeter or a coulomb counter, among other possibilities. Further, battery-level monitor 212 may be integrated with battery 210 or may be provided separately and interconnected with the battery.

To facilitate gaining access to a secure system (such as secure system 106 of FIG. 1), confidential and/or cryptographic data stored in secure element 208 may be used as a digital key in interaction with a corresponding digital lock 108 in the secure system. This process may take various forms. Without limitation, for example, digital key applet 222 and the digital lock of the secure system may use a challenge-response handshake, where the digital lock generates and sends a random value to digital key applet 222, the digital key applet uses a private key to sign the random value and sends the resulting digital signature back to the digital lock, and the digital lock then uses a public key to verify the digital signature as a condition for granting access to the secure system.

Using NFC, for example, digital key applet 222 of portable computing device 200 may engage in this type of challenge-response handshake, or another suitable exchange, with digital lock 108 of the secure system when wireless communication interface 206 of the portable computing device is brought in close enough proximity to the wireless communication interface of the secure system. For instance, wireless communication interface 206 of portable computing device 200 and/or the wireless communication interface of the secure system may regularly monitor for each other's presence and, upon inductively coupling with each other, may then signal to their associated digital key/digital lock to trigger the authentication process. Digital key applet 222 of portable computing device 200 may then wirelessly communicate with the digital lock of the secure system to establish authentication using the digital key and gain access to the secure system.

As noted above, the example portable computing device 200 may have a device-unlocked state and a device-locked state. These states may represent whether portable computing device 200 will allow a user to access certain device functions and data. For example, in the device-unlocked state, portable computing device 200 may allow the user to open and interact with certain applications on the portable computing device and to access certain user data stored on the portable computing device. Whereas in the device-locked state, the portable computing device may prevent the user from opening and interacting with those applications on the portable computing device and/or accessing that user data on the portable computing device.

Portable computing device 200 may be configured with lock-screen functionality to govern the lock state of the portable computing device. When portable computing device 200 is in the locked state, the portable computing device may limit a touch screen of user interface 202 to presenting a lock-screen GUI. The lock-screen GUI may allow some limited user interaction with applications and user data, through one or more lock-screen widgets, audio interfaces, or the like. However, portable computing device 200 may require user authentication as condition precedent for allowing the user to unlock the portable computing device and to more fully access applications and data on the portable computing device. Portable computing device 200 may be configured to authenticate the user through one or more user interface elements. For instance, if user interface 202 includes a biometric sensor as noted above, portable computing device 200 may be configured to engage in biometric authentication (e.g., sensing the user's fingerprint, face, retina, etc.), to prove the user's identity. In addition, or alternatively, the lock-screen GUI may present a prompt for the user to enter authentication credential information such as a passcode (e.g., to prove the user's identity).

Processing computing device 200 may be configured to operate in the locked state by default and may be configured to transition from the unlocked state to the locked state in response to various triggers. For example, portable computing device 200 may be configured to automatically transition from the unlocked state to the locked state upon passage of a predefined threshold time in which the portable computing device detects no user interaction with the portable computing device. Further, portable computing device 200 may be configured to transition from the unlocked state to locked state in response to user input, such as user pressing of a power button of the portable computing device.

In an example implementation, secure element 208 of portable computing device 200 may also have an unlocked state and a locked state and may switch between those states in various situations and maintain a persistent record of its current state. Further, the locked or unlocked state of secure element 208 may be based on the locked or unlocked state of the portable computing device 200. When portable computing device 200 is in the locked state, secure element 208 may be locked by default. When the portable computing device transitions from the locked state to the unlocked state, host controller 204 may then signal to secure element 208 to cause the secure element to transition from the locked state to the unlocked state, and the secure element may accordingly update its state record and proceed to operate in the unlocked state. Further, when portable computing device 200 transitions from the unlocked state to the locked state, host controller 204 may signal to secure element 208 to cause the secure element to transition from the unlocked state to the locked state, and the secure element may accordingly update its state record and proceed to operate in the locked state.

In an implementation, digital key applet 222 may further maintain a user authentication (UA) flag for the digital key that indicates whether to require user authentication as a condition precedent for allowing use of the digital key, and the digital key applet may use the state of that UA flag as a basis to control use of the digital key.

When secure element 208 is in the unlocked state, the secure element may operate as described above regardless of the state of the UA flag of the digital key, effectively treating the unlocked state of the secure element as an implicit user authentication. Namely, when secure element 208 is in the unlocked state and portable computing device 200 is brought in close enough proximity to the secure system, digital key applet 222 may engage in a cryptographic transaction with the secure system, using the digital key to gain access to the secure system.

On the other hand, when secure element 208 is in the locked state, the digital applet may use the state of the UA flag of the digital key as a basis to control whether to require user authentication as a condition precedent for allowing use of the digital key. Namely, when secure element 208 is locked and portable computing device 200 is brought in close enough proximity to the secure system, digital key applet 222 may determine whether the UA flag of the digital key is set to require user authentication, and based on that determination may control how to proceed.

When secure element 208 is in the locked state, the UA flag of the digital key is set to not require user authentication, and portable computing device 200 is brought in close enough proximity to the secure system, digital key applet 222 may operate as noted above, engaging in a cryptographic transaction with the secure system, using the digital key in order to gain access to the secure system.

When secure element 208 is in the locked state, the UA flag of the digital key is set to require user authentication, and portable computing device 200 is brought in close enough proximity to the secure system, digital key applet 222 may trigger a user authentication process, requiring user authentication as a condition precedent for allowing use of the digital key. For example, if the user brings portable computing device 200 close enough to the secure system when the secure element is locked and the UA flag of the digital key is set to require user authentication, digital key applet 222 may responsively signal to host controller 204 to trigger presentation of a user authentication prompt on user interface 202. If the user responds to that user authentication prompt by providing input to successfully authenticate the user, then portable computing device 200 may transition to the unlocked state and secure element 208 may accordingly also transition to the unlocked state, which may thereby enable digital key applet 222 to operate as noted above, using the digital key to gain access to the secure system. On the other hand, if the user does not respond to the user authentication prompt by providing input to successfully authenticate the user, then portable computing device 200 may remain in the locked state and secure element 208 may accordingly also remain in the locked state, which may prevent use of the digital key. In this scenario, in an implementation, digital key applet 222 may instead use a “dummy key” in a cryptographic transaction with the secure system, which may result in failure to access the secure system.

As noted above, when remaining battery energy of device 200 drops to a low enough level, portable computing device 200 may responsively shut down. Host controller 204 may manage this shut-down process based on battery-level information that host controller 204 receives from battery-level monitor 212. For instance, when signaling from battery-level monitor 212 indicates that the remaining energy of battery 210 has dropped to a first predefined threshold low level (e.g., a level in the range of approximately 2% to 5% of battery capacity, among other possibilities), host controller 204 may responsively shut down portable computing device 200.

Shutting down portable computing device 200 may involve disabling user interface functionality of the portable computing device, which would prevent or significantly restrict further user interface interaction with the portable computing device until battery 210 is recharged to a sufficient level to restore full operation. Further, if portable computing device 200 is in the unlocked state at the time, shutting down the portable computing device may involve host controller 204 transitioning the portable computing device from the unlocked state to the locked state, which as noted above may also involve locking secure element 208 and therefore preventing use of the digital key if the UA flag of the digital key is set to require user authentication.

Depending on the user interface technology and/or one or more other factors, user interface 202 of portable computing device 200 may present one or more indicia to the user when the portable computing device is shutting down or is shut down, or when user interface 202 transitions to be fully off and non-functional. Once battery 210 is recharged to a sufficient level, host controller 204 may then responsively restore full operation of portable computing device 200.

When portable computing device shuts down due to its remaining battery energy dropping to the first predefined threshold low level, the portable computing device may still have some remaining battery energy for a time (e.g., approximately an hour or so, depending on the threshold and battery condition). This remaining battery energy may be sufficient to power secure element 208 and wireless communication interface 206, which may thus be sufficient to allow use of the digital key to unlock the secure system if the secure element is unlocked and/or if the digital key's UA flag is set to not require user authentication. However, as noted above, shutting down portable computing device 200 may involve locking secure element 208, and if the UA flag of the digital key is set to require user authentication when the secure element is locked, this prevents use of the digital key until at least the portable computing device is sufficiently recharged.

To enable use of the digital key when portable computing device 200 has shut down due to its remaining battery energy dropping to the first predefined threshold low level, the portable computing device may have an associated user-controllable configurable setting. In an example implementation, portable computing device 200 may have a settings application, perhaps a settings module of digital key applet 222, that host controller 204 may execute upon user request, with the settings application providing various user-controllable configuration options for the portable computing device. In an implementation, one of those configuration options may be a “Ready Mode” option to allow use of the digital key once portable computing device 200 has shut down due to its remaining battery energy dropping to a threshold low level.

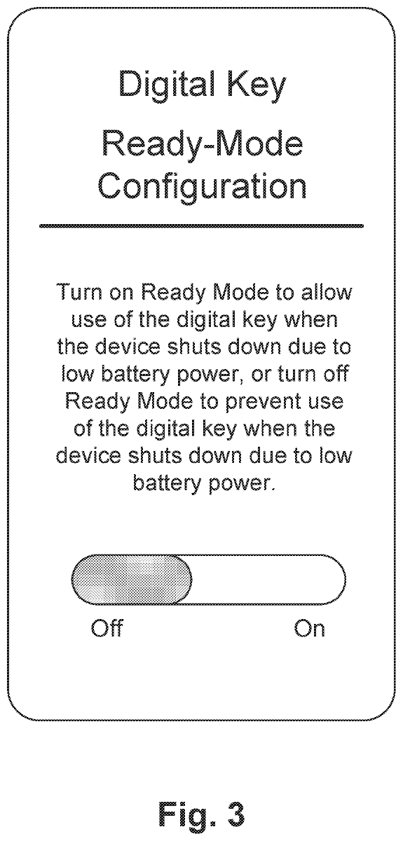

FIG. 3 illustrates an example configuration interface of the example portable computing device. The figure illustrates an example Ready Mode interface that portable computing device 200 may present on a touch screen of user interface 202 upon user request. As shown, the example Ready Mode interface presents a graphical slider control that the user could touch and slide to selectively turn Ready Mode either on or off. Further, the example interface includes text explaining to the user that: (i) turning on Ready Mode would allow use of the digital key when the portable computing device 200 shuts down due to low battery power; and (ii) turning off Ready Mode would prevent use of the digital key when portable computing device 200 shuts down due to low battery power.

The user may interact with this Ready Mode interface at some point when portable computing device 200 is in the unlocked state, and the user may decide whether to put the device in a Ready Mode “on” state or a Ready Mode “off” state. Further, host controller 204 may update device configuration data of the host controller accordingly to indicate whether to allow use of the digital key when portable computing device 200 shuts down due to its remaining battery energy dropping to the first predefined threshold low level. If the user sets the Ready Mode to “on”, then host controller 204 may set the device configuration data to indicate that portable computing device 200 should allow use of the digital key when the portable computing device shuts down due to its remaining battery energy dropping to the first predefined threshold low level. Whereas, if the user sets the Ready Mode to “off”, then host controller 204 may set the device configuration data to indicate that portable computing device should not allow use of the digital key when the portable computing device shuts down due to its remaining battery energy dropping to the first predefined threshold low level.

When portable computing device 200 shuts down due to its remaining battery energy dropping to the first predefined threshold low level, host controller 204 may accordingly control the UA flag of the digital key. Namely, as part of the shut-down process, host controller 204 may decide based on the Ready Mode configuration of portable computing device 200 whether the UA flag of the digital key should be set to require user authentication as a condition precedent for allowing use of the digital key. If the Ready Mode configuration indicates that portable computing device 200 should not allow use of the digital key when the portable computing device shuts down due to its remaining battery energy dropping to the first predefined threshold low level, then, as part of the shut-down process, host controller 204 may signal to secure element 208 to cause the secure element to set the UA flag of the digital key to the UA-required state, thereby preventing use of the digital key while the portable computing device is shut down. Whereas, if the Ready Mode configuration indicates that portable computing device 200 should allow use of the digital key when the portable computing device shuts down due to its remaining battery energy dropping to the first predefined threshold low level, then, as part of the shut-down process, host controller 204 may signal to secure element 208 to cause the secure element to set the UA flag of the digital key's to the UA-not-required state, thereby allowing use of the digital key for a period of time while the portable computing device is shut down.

As noted above, the present disclosure provides a mechanism to give the user of portable computing device 200 improved control over whether the digital key may be accessible when the portable computing device shuts down due to threshold low battery energy.

With this mechanism, portable computing device 200 may generally operate in a Ready Mode “off” state, in which the portable computing device would not allow use of the digital key when the device has shut down due to its remaining battery energy dropping the first predefined threshold low level. However, as discussed above, portable computing device 200 may be configured to detect when its remaining battery energy level drops to a second predefined threshold low level that is not as low as the first predefined threshold level (e.g., to a level in the range of approximately 5% to 15% of battery capacity, among other possibilities, and thereby not low enough to trigger shut-down of the device) and, in response to detecting that the remaining battery energy has dropped to the second predefined threshold low level (and before the remaining battery energy has dropped to the first predefined threshold low level), to prompt for user authentication as a basis for portable computing device 200 to turn on Ready Mode.

Upon successful user authentication in response to this prompt, portable computing device 200 may then turn on Ready Mode, so that, when the portable computing device subsequently shuts down due to its remaining battery energy dropping to the first predefined threshold level, the portable computing device may set the UA flag of the digital key to not require user authentication, thereby allowing use of the digital key for a period of time.

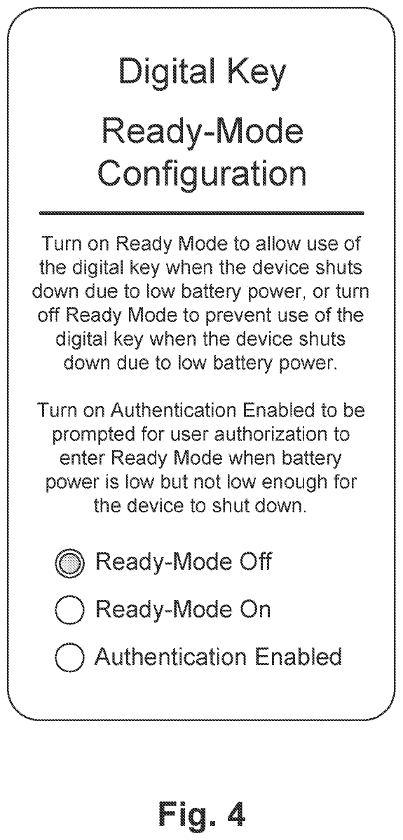

FIG. 4 illustrates another example configuration interface of the example portable computing device. Host controller 204 may provide a modified version of the Ready Mode settings interface, such as that shown by way of example in FIG. 4. This modified settings interface may provide the user with three digital key options: (i) Ready Mode on; (ii) Ready Mode off; and (iii) “Authentication Enabled”, The Ready Mode on and off options may function as noted above to turn Ready Mode on or off. The Authentication Enabled option, on the other hand, may function to have Ready Mode be off and to have host controller 204 prompt for user authentication to turn on Ready Mode when the remaining battery energy of portable computing device 200 drops to the second predefined threshold low level. Further, the modified interface includes text explaining these options, including an explanation that “Authentication Enabled” mode will cause the portable computing device to prompt the user to turn on Ready Mode when its battery level is low.

The user could interact with this modified Ready Mode interface when portable computing device 200 is in the unlocked state, and the user may decide which of these and/or other options to select. Further, host controller 204 may update its device configuration data accordingly to indicate whether portable computing device 200 is operating in the Ready Mode on state, the Ready Mode off state, or the Authentication Enabled state. If the user selects the Ready Mode on state or the Ready Mode off state, then host controller 204 may set the device configuration data accordingly as noted above. Whereas, if the user selects the Authentication Enabled state, then host controller 204 may set the device configuration data to indicate that Ready Mode is off and that, when the remaining battery energy of portable computing device drops to the second predefined threshold low level, the host controller prompts for user authentication as a basis to turn on Ready Mode.

In an example implementation, when the configuration data indicates the Authentication Enabled state, host controller 204 may monitor signaling from battery-level monitor 212 to determine when remaining energy of battery 210 has dropped to the second predefined threshold low level. In response to detecting that the remaining battery energy level has dropped to the second predefined threshold low level, and thus sufficiently before the remaining battery energy level may drop to the first predefined threshold low level, host controller 204 may then present on user interface 202 of portable computing device 200 a prompt for user authentication as a basis to turn on Ready Mode.

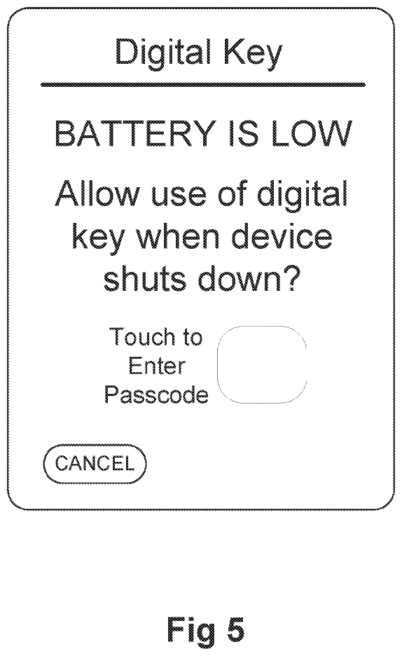

FIG. 5 illustrates an example user authentication prompt dialog of the example portable computing device. In this an example of a user authentication prompt, host controller 204 may present as a pop-up dialog on a touch screen of user interface 202 (e.g., superimposed over the lock screen GUI or superimposed over another currently active GUI). Alternatively, this user-authentication prompting may be done through audio output/input or in another manner. As shown, the example dialog includes text prompting the user to approve allowing access to the digital key in case portable computing device 200 later shuts down due to low battery energy. In particular, the example dialog states, “Allow use of digital key when device shuts down” and then prompts the user to touch a button of user interface 202 that may then bring the user to a passcode-entry keypad or other authentication interface where the user may provide authentication credentials to approve allowing use of the digital key when the portable computing device shuts down. Further, the example dialog includes a “Cancel” button that the user may touch to cancel the authentication process (to decline to allow use of the digital key when the device shuts down). Host controller 204 may also provide a haptic or other alert to the user, to notify the user that this user authentication prompt is being presented.

When host controller 204 presents this or another such user authentication prompt in response to the remaining battery energy of portable computing device 200 dropping to the second predefined threshold low level, the user may accordingly then decide whether the user would allow portable computing device 200 use of the digital key in case the portable computing device later shuts down due to remaining battery energy. If the user decides to allow that to happen, then the user may responsively engage in the user authentication process, which may involve entering a passcode or providing a fingerprint or other biometric input, among other possibilities, in which case host controller 204 may then responsively turn on Ready Mode. Whereas, if the user decides to not allow that to happen, then the user may responsively forgo engaging in the user authentication process, possibly by touching the “cancel” option on the user interface.

With this user authentication process, the user of portable computing device 200 gains improved control over whether the digital key may be accessible when the portable computing device shuts down due to low battery energy. If portable computing device 200 is in the Ready Mode off state in the first place, this user authentication process requires user authentication as a condition precedent to transitioning the portable computing device to the Ready Mode on state. By triggering this user authentication process in response to the remaining battery energy dropping to the second predefined threshold low level, portable computing device 200 may operate until then in the Ready Mode off state, helping to prevent a rogue actor from gaining access to the digital key by simply waiting for the portable computing device to shut down due to low battery energy. Further, by setting the second predefined threshold low level to be close enough to the first predefined threshold low level, use of this user authentication process may minimize the amount of time that portable computing device 200 is in the Ready Mode before the portable computing device shuts down, thus further helping to prevent a rogue actor from gaining access to the digital key by waiting for the portable computing device to shut down due to low battery energy.

In an example implementation, once portable computing device 200 has entered the Ready Mode on state in response to user authentication through this process, the portable computing device may then transition back to the Ready Mode off state once the portable computing device's battery 210 gets recharged to a predefined threshold high level (that is higher than the second predefined threshold low level). To facilitate this, when portable computing device 200 is in the Ready Mode on state as a result of user authentication through this process, host controller 204 may continue to monitor the portable computing device's remaining battery energy, and upon detecting that the battery energy has risen to the predefined threshold high level, the host controller may then transition the portable computing device from the Ready Mode on state to the Ready Mode off state.

Further, in an alternative implementation, the Authentication Enabled state of portable computing device 200 may instead work to trigger setting the UA flag of the digital key to the UA-not-required state as soon as the portable computing device successfully authenticates the user, rather than waiting until the portable computing device is shutting down. With this implementation, host controller 204 may present an authentication dialog to the user. Upon successful user authentication, however, rather than transitioning portable computing device 200 from Ready Mode off state to Ready Mode on state, the host controller may immediately signal to secure element 208 to cause the secure element to set the UA flag of the digital key to the UA-not-required state. Further, once the battery energy of portable computing device 200 then rises to a sufficiently high level, host controller 204 may direct secure element 208 to transition the UA flag of the digital key back to the UA-required state.

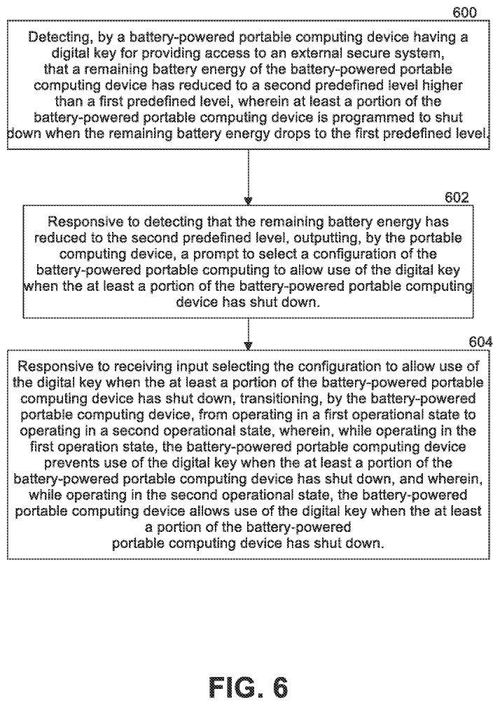

FIG. 6 illustrates controlling access to a digital key according to an implementation. the figure shows example operations of a battery-powered portable computing device in accordance with the present disclosure, where the portable computing device is programmed with a digital key for providing access to a secure system. As shown in FIG. 6, at block 600, the method includes detecting, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level. At block 602, the method includes responsive to detecting that the remaining battery energy has reduced to the second predefined level, outputting, by the portable computing device, a prompt to select a configuration of the battery-powered portable computing to allow use of the digital key when the at least a portion of the battery-powered portable computing device has shut down. At block 604, the method includes responsive to receiving input selecting the configuration to allow use of the digital key when the at least a portion of the battery-powered portable computing device has shut down, transitioning, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

Note also that the principles discussed above may apply as well with respect to a portable computing device configured with multiple digital keys, where each digital key facilitates accessing a respective secure system. For instance, a user's portable computing device may be configured with a digital key for the user's car and also a digital key for the user's house, and/or the portable computing device may be configured with a separate digital key respectively for each of multiple cars, among other possibilities.

In an example implementation, a secure element in such a portable computing device 200 may hold the multiple digital keys, and the portable computing device may be configured to give the user improved control with respect to the multiple digital keys. For example, the portable computing device may be configured to give the user improved control respectively per digital key as to whether the portable computing device allows use of the digital key when the portable computing device has shut down due to low battery energy, or the portable computing device may be configured to give the user improved control cooperatively for the multiple digital keys as to whether the portable computing device allows use of the digital keys when the device has shut down due to low battery energy.

Without limitation, the secure element could maintain respectively for each digital key a UA flag indicating whether user authentication is required as a condition precedent for allowing use of the digital key, and the portable computing device may carry out the operations described above respectively per digital key.

For example, host controller 204 may provide a modified version of the Ready Mode settings interface shown in FIG. 4, giving the user the noted options separately per digital key, so that the user could specify for each digital key whether the portable computing device 200 should operate in the Ready Mode on state, the Ready Mode off state, or the Authentication Enabled state. Further, as to each digital key for which the portable computing device is set to operate in the Authentication Enabled state, host controller 204 may respond to the portable computing device's battery energy dropping to a second predefined threshold low level by presenting a prompt such as that shown in FIG. 5, giving the user the option to have the portable computing device allow use of that digital key when the portable computing device later shuts down due to its battery energy dropping to a first predefined threshold low level.

In addition, to give the user further control, host controller 204 may allow the user to set the second predefined threshold low level of battery energy per digital key, so that the user could additionally control how soon before the portable computing device shuts down that the portable computing device would present a prompt such as that shown in FIG. 5 as to that digital key. For instance, in a modified version of the interface shown in FIG. 4, the host controller may present the user with a slider control per digital key, allowing the user to slide the control to set the second threshold low level, perhaps relative to the first threshold low level at which the portable computing device would likely shut down. This modified form of the interface of FIG. 4 may be used with a single-key implementation as well.

Alternatively, or additionally, host controller 204 provide cooperative control over multiple digital keys at once. For instance, a Ready Mode settings interface such as that shown in FIG. 4 may operate to select Ready Mode on, Ready Mode off, or Authentication Enabled globally for the multiple digital keys. Further, a prompt such as that shown in FIG. 5 may operate to prompt the user for approval to have the portable computing device allow use of each of the multiple keys when the portable computing device later shuts down due to its battery energy becoming threshold low.

In an example, the battery-powered portable computing device authenticates the user prior to transitioning the battery-powered portable computing device from the first operational state to the second operational state in response to the user selecting the configuration. In an example, the battery-powered portable computing device is to provide access to the digital key using short-range wireless communication between the battery-powered portable computing device and the external secure system. In an example, the battery-powered portable computing device provides access to the digital key when the battery-powered portable computing device is in the second operational state and the battery-powered portable computing device is in close enough proximity to the external secure system. In an example, the short-range wireless communication comprises Near Field Communication (NFC). In an example, providing access to the external secure system by the digital key of the battery-powered portable computing device comprises unlocking the external secure system.

In an example, the battery-powered portable computing device comprises one of a smart phone and a smart watch and the external secure system comprises one of a vehicle and a building. In an example, the battery-powered portable computing device comprises a secure element programmed to implement the digital key, wherein the secure element maintains a user authentication (UA) flag associated with the digital key, the UA flag having one of a UA-required state and a UA-not-required state, and wherein, when the battery-powered portable computing device has shut down due to the remaining battery energy being reduced to the first predefined level, the secure element allows use of the digital key when the UA flag is in the UA-required state and the user is authenticated, and allows use of the digital key when the UA flag is in the UA-not-required state. In an example, in the first operational state, the battery-powered portable computing device keeps the UA flag in the UA-required state when the battery-powered portable computing device shuts down in response to the remaining battery energy of the battery-powered portable computing device being reduced to the first predefined level, and in the second operational state, the battery-powered portable computing device transitions the UA flag from the UA-required state to the UA-not-required state when the battery-powered portable computing device shuts down in response to the remaining battery energy of the battery-powered portable computing device being reduced to the first predefined level.

Various aspects of the techniques described in this disclosure may enable the following examples.

Example 1. A method including detecting, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, outputting, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transitioning, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

Example 2. The method of Example 1, further comprising authenticating the user prior to transitioning the battery-powered portable computing device from the first operational state to the second operational state in response to the user selecting the configuration.

Example 3. The method of Example 1, wherein the battery-powered portable computing device provides access to the digital key using short-range wireless communication between the battery-powered portable computing device and the external secure system.

Example 4. The method of Example 3, further comprising providing access to the digital key when the battery-powered portable computing device is in the second operational state and the battery-powered portable computing device is in close enough proximity to the external secure system.

Example 5. The method of Example 3, wherein the short-range wireless communication comprises Near Field Communication.

Example 6. The method of Example 1, wherein providing access to the external secure system by the digital key of the battery-powered portable computing device comprises unlocking the external secure system.

Example 7. The method of Example 1, wherein the battery-powered portable computing device comprises one of a wearable computing device and the external secure system comprises one of a vehicle and a building.

Example 8. The method of Example 2, wherein the battery-powered portable computing device comprises a secure element programmed to implement the digital key, wherein the secure element maintains a user authentication flag associated with the digital key, the user authentication flag having one of a user authentication-required state and a user authentication—not-required state, and wherein, when the battery-powered portable computing device has shut down due to the remaining battery energy being reduced to the first predefined level, the secure element allows use of the digital key when the user authentication flag is in the user authentication-required state and the user is authenticated, and allows use of the digital key when the user authentication flag is in the user authentication-not-required state.

Example 9. The method of Example 8, wherein, in the first operational state, the battery-powered portable computing device keeps the user authentication flag in the user authentication-required state when the battery-powered portable computing device shuts down in response to the remaining battery energy of the battery-powered portable computing device being reduced to the first predefined level, and wherein, in the second operational state, the battery-powered portable computing device transitions the user authentication flag from the user authentication-required state to the user authentication-not-required state when the battery-powered portable computing device shuts down in response to the remaining battery energy of the battery-powered portable computing device being reduced to the first predefined level.

Example 10. An apparatus including a short-range wireless communication interface; a secure element programmed with a digital key operable through the short-range wireless communication interface to provide access to an external secure system; a battery; a user interface to engage in authentication of a user, wherein, when remaining energy of the battery has reduced to a first predefined level, the user interface is programmed to shut down and the authentication of the user is prevented; and a controller to detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

Example 11. The apparatus of Example 10, comprising the controller to authenticate the user prior to transitioning the apparatus from the first operational state to the second operational state in response to the user selecting the configuration.

Example 12. The apparatus of Example 10, comprising the secure element to provide access to the digital key over the short-range wireless communication interface when the apparatus is in the second operational state and the apparatus is in close enough proximity to the external secure system.

Example 13. The apparatus of Example 11, wherein the secure element maintains a user authentication flag associated with the digital key, the user authentication flag having one of a user authentication-required state and a user-authentication-not-required state, and wherein, when the user interface has shut down, the secure element allows use of the digital key when the user authentication flag is in the user-authentication-required state and the user is authenticated, and allows use of the digital key when the user-authentication flag is in the user-authentication-not-required state.

Example 14. A non-transitory machine-readable medium including instructions which, when executed by at least one processor, cause the at least one processor to: detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level; responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

Example 15. The non-transitory machine-readable medium of Example 14, comprising instructions which, when executed by at least one processor, cause the at least one processor to authenticate the user prior to transitioning the battery-powered portable computing device from the first operational state to the second operational state in response to the user selecting the configuration.

Example 16. An apparatus operative to perform the methods of any one of Examples 1 to 9. Example 17. An apparatus that includes means for performing any method of any one of Examples 1 to 9. Example 18. An apparatus that includes any combination of modules and/or units and/or logic and/or circuitry and/or means operative to perform the method of any one of Examples 1 to 9. Example 19. An optionally non-transitory and/or tangible machine-readable medium, which optionally stores or otherwise provides instructions that if and/or when executed by a computing system or other machine are operable to cause the machine to perform the method of any one of the Examples 1 to 9. Example 20. A device comprising one or more processors and a storage device encoded with instructions that, when executed by the one or more processors, cause the one or more processors to perform any combination of examples 1-9.

In one or more examples, the functions described may be implemented in hardware, software, firmware, or any combination thereof. If implemented in software, the functions may be stored on or transmitted over, as one or more instructions or code, a computer-readable medium and executed by a hardware-based processing unit. Computer-readable media may include computer-readable storage media, which corresponds to a tangible medium such as data storage media, or communication media including any medium that facilitates transfer of a computer program from one place to another, e.g., according to a communication protocol. In this manner, computer-readable media generally may correspond to (1) tangible computer-readable storage media, which is non-transitory or (2) a communication medium such as a signal or carrier wave. Data storage media may be any available media that can be accessed by one or more computers or one or more processors to retrieve instructions, code and/or data structures for implementation of the techniques described in this disclosure. A computer program product may include a computer-readable medium.

By way of example, and not limitation, such computer-readable storage media can comprise RAM, ROM, EEPROM, CD-ROM or other optical disk storage, magnetic disk storage, or other magnetic storage devices, flash memory, or any other medium that can be used to store desired program code in the form of instructions or data structures and that can be accessed by a computer. Also, any connection is properly termed a computer-readable medium. For example, if instructions are transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of medium. It should be understood, however, that computer-readable storage media and data storage media do not include connections, carrier waves, signals, or other transient media, but are instead directed to non-transient, tangible storage media. Disk and disc, as used, includes compact disc (CD), laser disc, optical disc, digital versatile disc (DVD), floppy disk and Blu-ray disc, ultra Blu-ray, etc. where disks usually reproduce data magnetically, while discs reproduce data optically with lasers. Combinations of the above should also be included within the scope of computer-readable media.

Instructions may be executed by one or more processors, such as one or more digital signal processors (DSPs), general purpose microprocessors, application specific integrated circuits (ASICs), field programmable logic arrays (FPGAs), or other equivalent integrated or discrete logic circuitry. Accordingly, the term “processor,” as used may refer to any of the foregoing structure or any other structure suitable for implementation of the techniques described. In addition, in some aspects, the functionality described may be provided within dedicated hardware and/or software modules. Also, the techniques could be fully implemented in one or more circuits or logic elements.

The techniques of this disclosure may be implemented in a wide variety of devices or apparatuses, including a wireless handset, an integrated circuit (IC) or a set of ICs (e.g., a chip set). Various components, modules, or units are described in this disclosure to emphasize functional aspects of devices configured to perform the disclosed techniques, but do not necessarily require realization by different hardware units. Rather, as described above, various units may be combined in a hardware unit or provided by a collection of interoperative hardware units, including one or more processors as described above, in conjunction with suitable software and/or firmware.

Exemplary embodiments have been described above. Those skilled in the art will understand, however, that changes and modifications may be made to these embodiments without departing from the true scope and spirit of the invention.

1. A method comprising:
detecting, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level;
responsive to detecting that the remaining battery energy has reduced to the second predefined level, outputting, by the portable computing device, a prompt to select a configuration of the battery-powered portable computing to allow use of the digital key when the at least a portion of the battery-powered portable computing device has shut down; and
responsive to receiving input selecting the configuration to allow use of the digital key when the at least a portion of the battery-powered portable computing device has shut down, transitioning, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

2. The method of claim 1, further comprising authenticating a user prior to transitioning the battery-powered portable computing device from the first operational state to the second operational state in response to the user selecting the configuration.

3. The method of claim 1, wherein the battery-powered portable computing device provides access to the digital key using short-range wireless communication between the battery-powered portable computing device and the external secure system.

4. The method of claim 3, further comprising providing access to the digital key when the battery-powered portable computing device is in the second operational state and the battery-powered portable computing device is in close enough proximity to the external secure system.

5. The method of claim 3, wherein the short-range wireless communication comprises Near Field Communication.

6. The method of claim 1, wherein providing access to the external secure system by the digital key of the battery-powered portable computing device comprises unlocking the external secure system.

7. The method of claim 1, wherein the battery-powered portable computing device comprises one of a wearable computing device and the external secure system comprises one of a vehicle and a building.

8. The method of claim 2,
wherein the battery-powered portable computing device comprises a secure element programmed to implement the digital key, wherein the secure element maintains a user authentication flag associated with the digital key, the user authentication flag having one of a user authentication-required state and a user authentication-not-required state, and
wherein, when the battery-powered portable computing device has shut down due to the remaining battery energy being reduced to the first predefined level, the secure element allows use of the digital key when the user authentication flag is in the user authentication-required state and the user is authenticated, and allows use of the digital key when the user authentication flag is in the user authentication-not-required state.

9. The method of claim 8,
wherein, in the first operational state, the battery-powered portable computing device keeps the user authentication flag in the user authentication-required state when the battery-powered portable computing device shuts down in response to the remaining battery energy of the battery-powered portable computing device being reduced to the first predefined level, and
wherein, in the second operational state, the battery-powered portable computing device transitions the user authentication flag from the user authentication-required state to the user authentication-not-required state when the battery-powered portable computing device shuts down in response to the remaining battery energy of the battery-powered portable computing device being reduced to the first predefined level.

10. An apparatus comprising:
a short-range wireless communication interface;
a secure element programmed with a digital key operable through the short-range wireless communication interface to provide access to an external secure system;
a battery;
a user interface to engage in authentication of a user, wherein, when remaining energy of the battery has reduced to a first predefined level, the user interface is programmed to shut down and the authentication of the user is prevented; and
a controller to
detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level;
responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and
responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

11. The apparatus of claim 10, comprising the controller to authenticate a user prior to transitioning the apparatus from the first operational state to the second operational state in response to the user selecting the configuration.

12. The apparatus of claim 10, comprising the secure element to provide access to the digital key over the short-range wireless communication interface when the apparatus is in the second operational state and the apparatus is in close enough proximity to the external secure system.

13. The apparatus of claim 11, wherein the secure element maintains a user authentication flag associated with the digital key, the user authentication flag having one of a user authentication-required state and a user-authentication-not-required state, and wherein, when the user interface has shut down, the secure element allows use of the digital key when the user authentication flag is in the user authentication-required state and the user is authenticated, and allows use of the digital key when the user authentication flag is in the user-authentication-not-required state.

14. A non-transitory machine-readable medium comprising instructions which, when executed by at least one processor, cause the at least one processor to:
detect, by a battery-powered portable computing device having a digital key for providing access to an external secure system, that a remaining battery energy of the battery-powered portable computing device has reduced to a second predefined level higher than a first predefined level, wherein at least a portion of the battery-powered portable computing device is programmed to shut down when the remaining battery energy drops to the first predefined level;
responsive to detecting that the remaining battery energy has reduced to the second predefined level, output, by the portable computing device, a prompt to select a configuration of the battery-powered portable computing to allow use of the digital key when the at least a portion of the battery-powered portable computing device has shut down; and
responsive to receiving input selecting the configuration to allow use of the digital key when the at least a portion of the battery-powered portable computing device has shut down, transition, by the battery-powered portable computing device, from operating in a first operational state to operating in a second operational state, wherein, while operating in the first operation state, the battery-powered portable computing device prevents use of the digital key when the at least a portion of the battery-powered portable computing device has shut down, and wherein, while operating in the second operational state, the battery-powered portable computing device allows use of the digital key when the at least a portion of the battery-powered portable computing device has shut down.

15. The non-transitory machine-readable medium of claim 14, comprising instructions which, when executed by the at least one processor, cause the at least one processor to:
authenticate a user prior to transitioning the battery-powered portable computing device from the first operational state to the second operational state in response to the user selecting the configuration.

16. The apparatus of claim 13,
wherein, in the first operational state, the battery-powered portable computing device keeps the user authentication flag in the user authentication-required state when the battery-powered portable computing device shuts down in response to the remaining battery energy of the battery-powered portable computing device being reduced to the first predefined level, and
wherein, in the second operational state, the battery-powered portable computing device transitions the user authentication flag from the user authentication-required state to the user authentication-not-required state when the battery-powered portable computing device shuts down in response to the remaining battery energy of the battery-powered portable computing device being reduced to the first predefined level.

17. The non-transitory machine-readable medium of claim 15, wherein the battery-powered portable computing device comprises one of a wearable computing device and the external secure system comprises one of a vehicle and a building.

18. The non-transitory machine-readable medium of claim 15, wherein the instructions further cause the at least one processor to:
provide access to the digital key using short-range wireless communication between the battery-powered portable computing device and the external secure system.

19. The non-transitory machine-readable medium of claim 18, wherein the instructions further cause the at least one processor to:
provide access to the digital key when the battery-powered portable computing device is in the second operational state and the battery-powered portable computing device is in close enough proximity to the external secure system.

20. The non-transitory machine-readable medium of claim 18, wherein the short-range wireless communication comprises Near Field Communication.
